(19) United States
(12) Patent Application Publication
(10) Pub. No.: US 2010/0294718 A1
(43) Pub. Date: Nov. 25, 2010

(54) LIQUID PURIFICATION SYSTEM USING A MEDIUM PRESSURE MEMBRANE

(75) Inventor: Jean-Francois Treyvaud, La Tour-de-peilz (CH)

Correspondence Address: SHERIDAN ROSS PC, 1560 BROADWAY, SUITE 1200, DENVER, CO, 80202, US

(73) Assignee: SWISS FRESH WATER SA, Belmont-lausanne (CH)

(21) Appl. No.: 12/663,318

(22) PCT Filed: Jun. 9, 2008
(86) PCT No.: PCT/IB2008/052266

§ 371 Date: May 25, 2010

(30) Foreign Application Priority Data
Jun. 8, 2007 (CH) 00918/07

(51) Int. Cl. B01D 61/02; B01D 61/08

(52) U.S. Cl. 210/652; 210/321.72

(57) ABSTRACT

The invention relates to a reverse-osmosis purification system that comprises at least one liquid supply (1) for supplying a liquid to be processed simultaneously into two chambers (A1B) of a separation member (3), said chambers being separated by a semi-pervious membrane, the liquid being fed into one chamber at a pressure higher than that of the liquid in the other chamber, said separation member (3) providing at the outlet a concentrated liquid (5) and a diluted liquid (6).

### FIELD OF THE INVENTION

The present invention relates to the field of the purification of a liquid by passing it through membranes.

In particular, the present invention relates to the field of desalination of water, notably, for example, of sea water.

### PRIOR ART

Numerous water purification systems are known in the prior art.

Reverse osmosis is one of the processes used, particularly for the desalination of sea water. This process is copiously described in the available literature (for example in Degrémont's “Mémento . . . de l'eau”).

Reverse osmosis is a system for purifying water by passing it under pressure through a semi-permeable membrane which preferably keeps back the dissolved compounds but allows the water to pass through under the effect of the applied pressure.

Consider the case of water containing solutes, particularly salt. If two solutions at different concentrations are placed on each side of a filter membrane, water crosses this membrane until the concentrations reach equilibrium. This is the phenomenon of osmosis. By applying a hydrostatic pressure in the opposite direction, the osmotic pressure is countered and the water is forced to cross the membrane in the opposite direction, making it possible to obtain, on one side, water in which the solutes are more dilute (and therefore purer water), known as the permeate, and, on the other side, more concentrated water known as the concentrate.

The disadvantages of reverse osmosis are: the life of the membranes (usually about 3 to 5 years) water losses: what happens is that the concentrate which contains all the salts that have not passed through the membrane or membranes contains too much salt and represents a loss;

the energy consumed by the pressurizing pump: the pressure applied has to be higher than osmotic pressure. For example, in the case of sea water containing approximately 36 g/l of salt, the osmotic pressure is about 29 bar and the pressure usually applied in order to cause a reverse-osmosis flow is habitually of the order of 50 to 60 bar.

There are technical devices for optimizing energy consumption. In particular, it is possible to use mechanical energy-recuperation systems such as Pelton turbines for example, which are able to recuperate energy contained in the concentrate and use it to pressurize the raw water. These systems are commonly employed in industrial-scale plants, but are difficult to use in smaller-scale plants.

It is also possible to optimize the energy consumption and water losses by assembling several reverse-osmosis stages, combined in series or in parallel.

By way of example, patent U.S. Pat. No. 6,187,200 describes a device using reverse osmosis to desalinate sea water. In the system illustrated, the water for desalination is injected under pressure (by a pump) into a first stage from which there emerges a first dilute flow and a first concentrated flow. This first concentrated flow is injected under pressure (by a pump) into a second stage from which there in turn emerges a second dilute flow and a second concentrated flow. The second dilute flow is mixed with the first dilute flow and the second concentrated flow is used in an energy-recuperation system.

### GENERAL PRINCIPLE

One object of the invention is to improve the known processes and devices for purifying water or other liquids using reverse osmosis.

More specifically, one of the objects of the invention is to propose a liquid purification process and system which optimizes energy consumption even without having to resort to a mechanical recuperation device.

Another object of the invention is to propose a process and a system which are simple and inexpensive to implement.

The system according to the invention uses reverse osmosis and a special distribution of the flows to purify the water at a pressure lower than the pressure conventionally used, this having the effect of reducing the energy consumption and allowing a more rudimentary design which optimizes system construction costs. The use of the system according to the invention is particularly ideal for desalinating sea water.

### DETAILED DESCRIPTION

One of the principles of the invention is to carry out purification in several stages, the first stage being devoted to pre-diluting the flow of raw water.

In this first stage, predilution is performed by supplying the semi-permeable membrane not only on the concentrate side (side A) but also on the permeate side (side B) with liquids of the same concentration or similar concentration in compounds that are to be separated. The concentration in compounds to be separated is therefore similar on each side of the membrane.

By comparison with all the conventional systems which do not supply the permeate side, the osmotic pressure is thus greatly reduced and the pressure that has to be applied in order to cause water to flow through the membrane is thus greatly reduced.

The liquid thus obtained on the permeate side (side B) is a mixture of a proportion highly laden with solute, which comes from the supply, and of the liquid containing very little solute, which has passed through the membrane. The resultant mean concentration is very much diluted by comparison with the raw water supply, and can easily be treated at a medium pressure in a conventional reverse-osmosis system.

The system according to the invention also works with liquids of different concentration.

The system according to the invention can be mounted in combination (in series and/or in parallel) with identical stages and/or with other conventional reverse-osmosis stages.

The overall energy consumption of a system comprising a predilution stage employing the principle of the invention is significantly reduced.

A mechanical energy-recuperation system is an additional option for optimizing energy consumption.

The attached figures depict various possible configurations of the system, by way of nonlimiting examples.

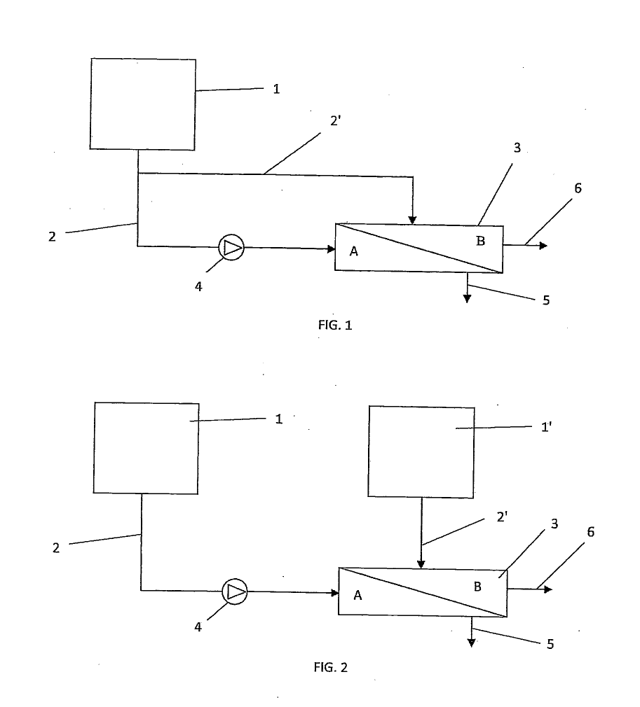

FIG. 1 shows a first embodiment.

FIG. 2 shows a second embodiment.

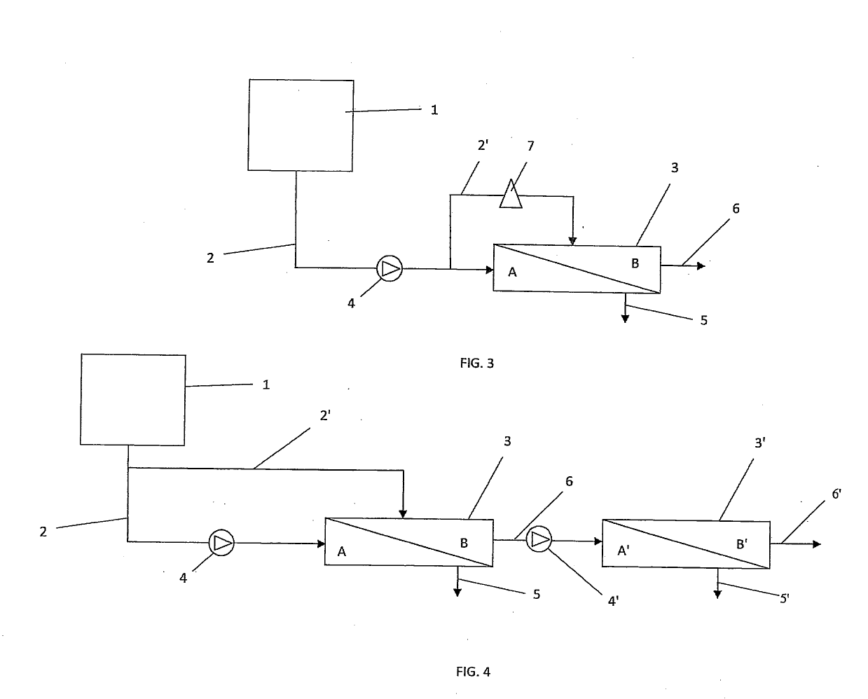

FIG. 3 shows a third embodiment.

FIG. 4 shows a fourth embodiment.

In the first embodiment (FIG. 1) a liquid, for example salt water with a salt concentration of 36 g/l, is contained in a reservoir 1. From this reservoir, the liquid is conveyed by a supply 2, 2′ to a separation element 3 which uses the principle of reverse osmosis. Before arriving at this element 3, the liquid is divided into two flows, one of the flows arriving in the separation element directly (on side B) and the other flow being pressurized, for example by a pump 4 or another equivalent means, before entering the separation element on the other side of the membrane (side A). Thus, in this element, the same liquid can be found on both sides of the reverse-osmosis filter, but on one side (A) the liquid is at a higher pressure than on the other side (B). Thanks to the principle of reverse osmosis, a concentrated liquid 5, on the one hand, and a dilute liquid 6, on the other hand, are obtained on the outlet side of the separation element 3.

In the second embodiment (FIG. 2), use is made of two sources of liquid in two reservoirs 1 and 1′. That makes it possible, amongst other things, to use liquids with different concentrations. As before, one of the liquids is pressurized with respect to the other, for example using a pump 4. The other elements that are similar to those described with reference to FIG. 1 are referenced identically, and the description given hereinabove applies in an equivalent way. Of course, other equivalent means may be used for performing this pressurizing. Furthermore, it would also be possible to use two pumps (one for each liquid), supplying the separation element 3 with liquid at different pressures according to the principle of the invention.

In the third embodiment (FIG. 3), the pump 3 is positioned upstream of the separation of the fluid flows, and a pressure reducer 7 is therefore added to the side B supply in order to obtain a pressure difference across the separation element 2 according to the reverse-osmosis principle. The other elements similar to the embodiments of FIGS. 1 and 2 are referenced identically.

The fourth embodiment (FIG. 4) shows a two-stage embodiment of the device according to the invention. In this embodiment, the first stage (on the left in the figure) depicted is a treatment device corresponding to that of FIG. 1 (with the same references) and the description of this embodiment given hereinabove applies accordingly. This first stage, which is used as a predilution stage, is followed, downstream, by a second stage for treating the dilute liquid, comprising a pressurizing means 4′ (for example a pump), a separation element 3′ (with the chambers A′ and B′) supplying, as output, a concentrated liquid 5′ on the one hand, and a dilute liquid 6′ on the other.

As will be appreciated, the first stage used in the embodiment of FIG. 4 may be that of FIG. 1, or 2 or 3 equivalently and FIG. 4 merely illustrates one possible embodiment. Other options may include a cascade of several successive elements.

Of course, the examples indicated are given by way of nonlimiting indication, and variations in the implementation of the predilution stage are possible. It is also possible to use the system according to the invention in series and/or in parallel by using several stages.

Likewise, the invention may be used for applications other than the desalination of water and for liquids other than water.

1. A reverse-osmosis purification system comprising at least one liquid supply supplying a liquid to be treated to two chambers of a separation element simultaneously, said chambers being separated by a semi-permeable membrane, the liquid being conveyed into one of the chambers at a pressure higher than that of the liquid in the other chamber, said separation element supplying as output a concentrated liquid and a dilute liquid.

2. The system as claimed in claim 1, in which the liquid supply comprises a supply in two branches of which at least one is placed under pressure by a pressurizing means and the other comprises a bypass of said means, each branch supplying one chamber of said separation element.

3. The system as claimed in claim 1, in which the liquid supply comprises a supply in two independent branches of which at least one is placed under pressure by a pressurizing means, each branch supplying one chamber of said separation element and each branch being connected to a reservoir.

4. The system as claimed in claim 1, in which the supply comprises a first branch placed under pressure by a pressurizing means to supply the first chamber, and a second branch tapped off said first branch downstream of said pressurizing means, said second branch comprising a pressure reducer for supplying the second chamber at a pressure that is reduced with respect to that of the first chamber.

5. A system comprising, by way of pre-dilution stage, a system as claimed in claim 1 and additionally comprising at least one second, separation stage using a semi-permeable membrane into which stage the dilute liquid is conveyed, so as to be separated into, on one side, a purified liquid and, on the other, a concentrated liquid.

6. A device for treating liquids, for example water, comprising several systems as claimed in claim 1.

7. A treatment process using at least one system as claimed in claim 1.

8. A process for treating a liquid laden with dissolved compounds and comprising the following steps:
the liquid to be treated is conveyed into two chambers of a separation element, said chambers being separated by a semi-permeable membrane and said liquid being under pressure in one of said chambers so as to produce a reverse-osmosis effect, a concentrated liquid and a dilute liquid are collected by way of output from the separation element.

9. The process as claimed in claim 8, in which several successive reverse-osmosis steps are performed.
